(19) United States
(12) Patent Application Publication
(10) Pub. No.: US 2013/0215388 A1
(43) Pub. Date: Aug. 22, 2013

(54) IMAGE PROCESSING APPARATUS, DIAGNOSTIC SUPPORT SYSTEM, AND IMAGE PROCESSING METHOD

(71) Applicant: CANON KABUSHIKI KAISHA, (US)

(72) Inventor: Hiroshi Imamura, Kyoto-shi (JP)

(73) Assignee: CANON KABUSHIKI KAISHA, Tokyo (JP)

(21) Appl. No.: 13/769,129

(22) Filed: Feb. 15, 2013

(30) Foreign Application Priority Data
Feb. 20, 2012 (JP) 2012-034346

(51) Int. Cl. G06K 9/00

(52) U.S. Cl. CPC G06K 9/00127
USPC 351/206; 382/134

(57) ABSTRACT

An image processing apparatus includes a specification unit configured to specify a vascular region based on a movement of a blood cell in a moving image of an ocular portion captured by an ophthalmologic imaging apparatus including an adaptive optics system, and a determination unit configured to determine presence of an abnormality based on the specified vascular region.

### BACKGROUND OF THE INVENTION

1. Field of the Invention

This disclosure relates to an image processing apparatus and an image processing method, and in particular, to an image processing apparatus, a diagnostic support system, and an image processing method for use in an ophthalmologic examination and treatment.

2. Description of the Related Art

It is known that retinal circulatory disturbance such as diabetic retinopathy causes an abnormality at a capillary vessel around a parafovea at an early stage of the disease. For example, diabetic retinopathy causes a microaneurysm at a capillary vessel, a tortuous capillary vessel, and an occlusion of a capillary vessel (an expansion of an avascular region). Further, such a change in morphology leads to generation of a region where the velocity of blood flow slows down.

So far, fluorescein fundus angiography has been conducted to visually evaluate a lesion at such a microcirculation (a capillary vessel). The fluorescein fundus angiography is a standard examination, but is highly invasive and can provide only a qualitative evaluation. As other examination methods, there are non-invasive blood flow measurement methods such as the laser speckle method and the laser Doppler method, but the thinnest blood vessel that these methods can measure is an arteriolar, and thus it is difficult to measure the velocity of blood flow in a capillary vessel.

Further, detecting an abnormality in morphology and moving state in a capillary vessel and a blood cell involves such problems that there are a large number of vessels that makes the measurement thereof cumbersome, and in many cases, it is difficult to detect a lesion based on a fixed criterion since a determination criterion varies depending on an observer.

As a technique for measuring the velocity of blood flow in an image of an ocular portion, Japanese Patent Application Laid-Open No. 2001-275975 discusses a technique for calculating, by the laser Doppler method, the velocity of blood flow from an image of a fundus and an estimated blood flow amount from a vascular diameter, and evaluating a normality or abnormality by comparing the estimated blood flow amount with a measured blood flow amount. Alternatively, U.S. Pat. No. 6,588,901 discusses a method for locating the position of a red blood cell and directly measuring the moving velocity thereof.

### SUMMARY OF THE INVENTION

According to an aspect of the present invention, an image processing apparatus includes a specification unit configured to specify a vascular region based on a movement of a blood cell in a moving image of an ocular portion captured by an ophthalmologic imaging apparatus including an adaptive optics system, and a determination unit configured to determine presence of an abnormality based on the specified vascular region.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a functional configuration of an image processing apparatus according to a first exemplary embodiment.

FIG. 2 is a block diagram illustrating an example of a configuration of a system including the image processing apparatus according to the first exemplary embodiment.

FIG. 3 is a block diagram illustrating an example of a hardware configuration of a computer that includes hardware corresponding to a storage unit and an image processing unit according to the first exemplary embodiment, and holds and executes other respective units as software.

FIG. 4 is a flowchart illustrating processing to be performed by the image processing apparatus according to the first exemplary embodiment.

FIGS. 5A, 5B, 5C, 5D, 5E, and 5F illustrate a content of image processing according to the first exemplary embodiment.

FIG. 6 is a flowchart illustrating details of the processing according to the first exemplary embodiment.

FIG. 7 is a block diagram illustrating an example of a functional configuration of an image processing apparatus according to a second exemplary embodiment.

FIG. 8 is a flowchart illustrating processing to be performed by the image processing apparatus according to the second exemplary embodiment.

FIG. 9 is a block diagram illustrating an example of a functional configuration of an image processing apparatus according to a third exemplary embodiment.

FIG. 10 is a flowchart illustrating processing to be performed by the image processing apparatus according to the third exemplary embodiment.

FIG. 11 is a flowchart illustrating details of the processing according to the third exemplary embodiment.

### DESCRIPTION OF THE EMBODIMENTS

Various exemplary embodiments, features, and aspects of the invention will be described in detail below with reference to the drawings.

An image processing apparatus according to a first exemplary embodiment will be described as an example that measures the moving velocity of a blood cell after specifying a blood cell region from a scanning laser ophthalmoscope (SLO) moving image obtained by capturing a parafovea of a macular portion, and compares the measured moving velocity with a normal value or a result of measurement of another region to thereby detect an abnormality in a moving state of the blood cell.

More specifically, the image processing apparatus according to the first exemplary embodiment will be described as the following example. A specification unit 141 specifies a high-luminance blood cell region by performing differential processing on an SLO moving image D obtained by capturing a parafovea of a macular portion. A measurement unit 142 detects the locus of a blood cell in a spatiotemporal image generated from the difference image, and calculates the moving velocity thereof. A determination unit 143 compares the calculated moving velocity with a normal value or a measurement value in another region to thereby detect an abnormality in a moving state of the blood cell. This configuration will be described below.

According to this configuration, an abnormality in blood flow generated at a capillary vessel in an ocular portion can be detected automatically and non-invasively.

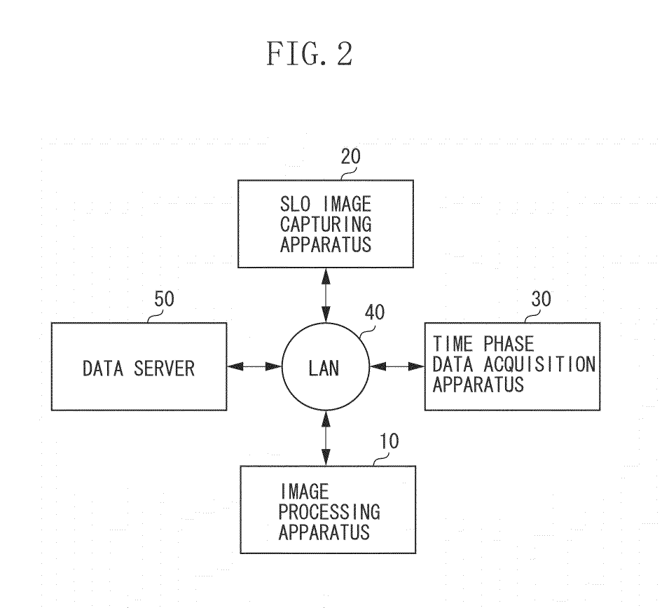

FIG. 2 illustrates a configuration of a diagnostic support system including an image processing apparatus 10 according to the present exemplary embodiment. As illustrated in FIG. 2, the image processing apparatus 10 is connected to an SLO image capturing apparatus 20, a time phase data acquisition apparatus 30, and a data server 50 via a local area network (LAN) 40 constituted by, for example, an optical fiber, a Universal Serial Bus (USB) cable, or an Institute of Electrical and Electronics Engineers (IEEE) 1394 cable. Alternatively, the diagnostic support system may be configured in such a manner that the image processing apparatus 10 is connected to these apparatuses via an external network such as the Internet.

The SLO image capturing apparatus 20 is an adaptive optics-scanning laser ophthalmoscope (AO-SLO) including an adaptive optics system, and is an apparatus for capturing a planar image (an SLO moving image) of a fundus portion.

The adaptive optics-scanning laser ophthalmoscope (AO-SLO) includes a super luminescent diode (SLD), which is a light source, a Shack-Hartmann wavefront sensor, which is an aberration measurement system, an adaptive optics system, which is an aberration correction system, a beam splitter, an X-Y scanning mirror, a focus lens, a diaphragm, an optical sensor, an image forming unit, and an output unit.

Light emitted from the SLD light source is reflected on a fundus. Part of the light is input to the Shack-Hartmann wavefront sensor via a second beam splitter, and the rest of the light is input into the optical sensor via a first beam splitter. The Shack-Hartmann wavefront sensor is a device for measuring an aberration of an eye, and a charge coupled device (CCD) sensor is connected to a lens array. When incident light is transmitted through the lens array, a bright spot group appears in the CCD sensor, and a wavefront aberration is measured based on a positional deviation among the projected bright spots. The adaptive optics system corrects the aberration by driving an aberration correction device (a variable shape mirror or a spatial light phase modulator) based on the wavefront aberration measured by the Shack-Hartmann wavefront sensor. The aberration-corrected light is received by the optical sensor via the focus lens and the diaphragm. The AO-SLO can control a scanned position on a fundus by moving the X-Y scanning mirror, and acquires data of an imaging target region and a time (a frame rate x the number of frames) specified by an operator in advance. The AO-SLO transmits the data to the image forming unit, and forms image data (a moving image or a still image) by correcting an image distortion due to a variation in scanning velocities and correcting a luminance value. As a result, image data less affected by the aberration can be obtained. The output unit outputs the image data formed by the image forming unit. To focus on a specified depth position on a fundus, focus adjustment may be performed with use of the aberration correction device in the adaptive optics system, or may be performed by providing a not-illustrated focus adjustment lens in the optics system to move the lens.

The SLO image capturing apparatus 20 captures an SLO moving image D, and transmits the SLO moving image D and information of a fixation target position F used at the time of capturing the SLO moving image D to the image processing apparatus 10 and the data server 50.

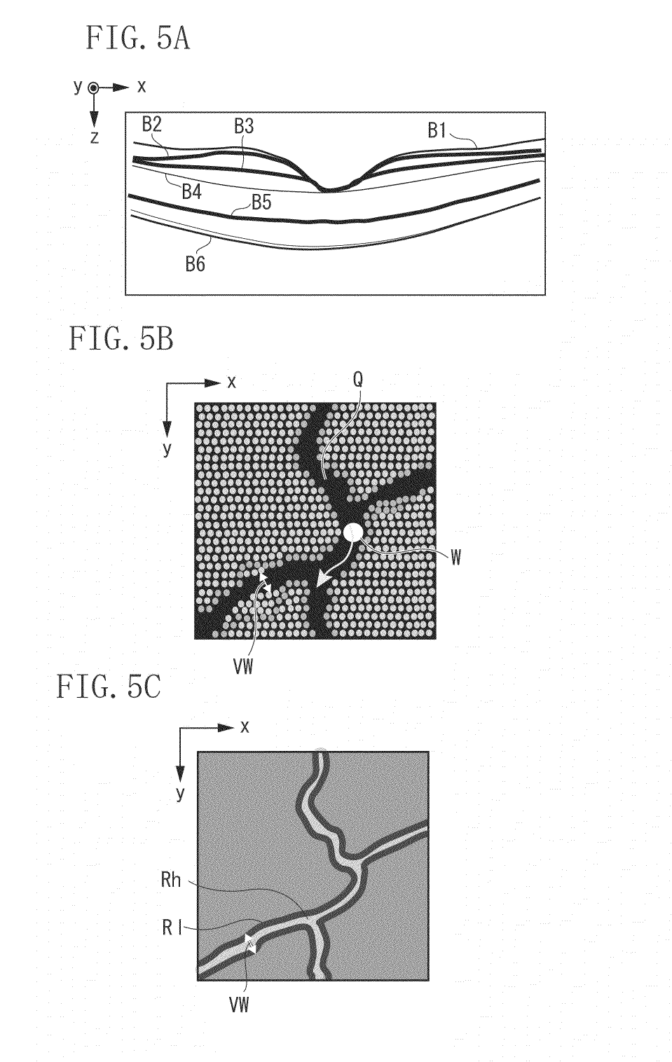

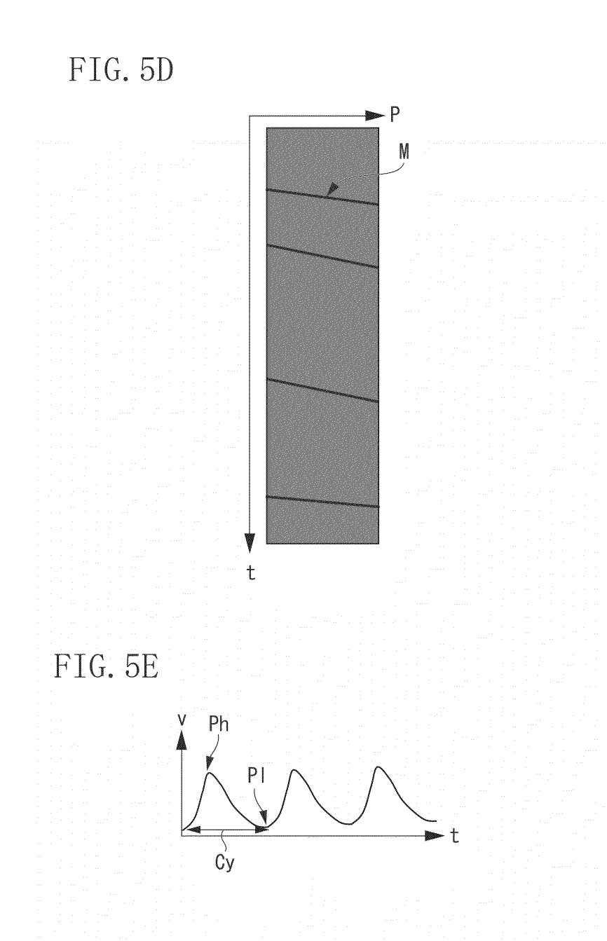

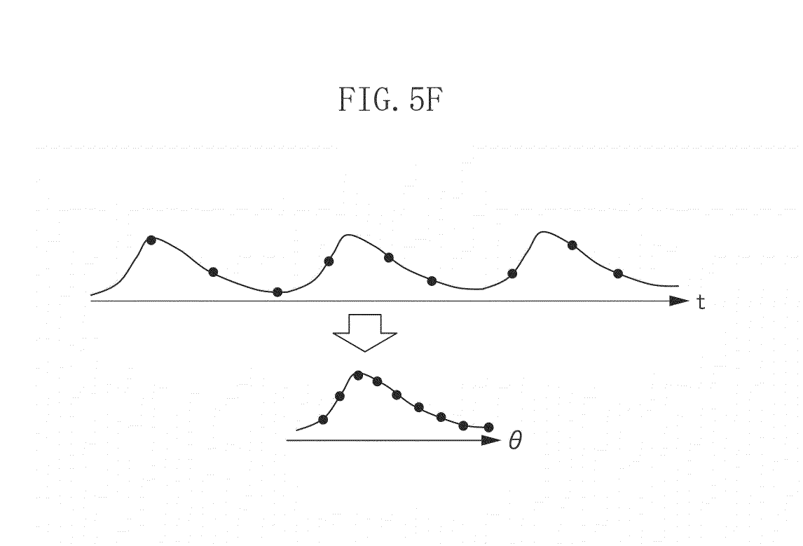

The time phase data acquisition apparatus 30 is an apparatus for acquiring autonomously changing biological signal data (time phase data P), and is embodied by, for example, a sphygmograph or an electrocardiograph. The time phase data acquisition apparatus 30 acquires the time phase data P at the same time as acquisition of the SLO moving image D in response to an operation by a not-illustrated operator. As illustrated in FIG. 5E, the time phase data P is expressed as a point sequence having an acquisition time t on one axis and a pulse wave signal value v measured by the sphygmograph on the other axis. The acquired time phase data P is transmitted to the image processing apparatus 10 and the data server 50.

The data server 50 holds, for example, image capturing condition data such as the SLO moving image D of an eye to be examined and the fixation target position F, the time phase data P, an image feature of an ocular portion, and a normal value of the image feature. The SLO moving image D and the fixation target position F output from the SLO image capturing apparatus 20, the time phase data P output from the time phase data acquisition apparatus 30, and an image feature of an ocular portion output from the image processing apparatus 10 are stored in the data server 50. Further, the data server 50 transmits the SLO moving image D, the time phase data P, an image feature of an ocular portion, and normal value data of the image feature to the image processing apparatus 10, in response to a request from the image processing apparatus 10.

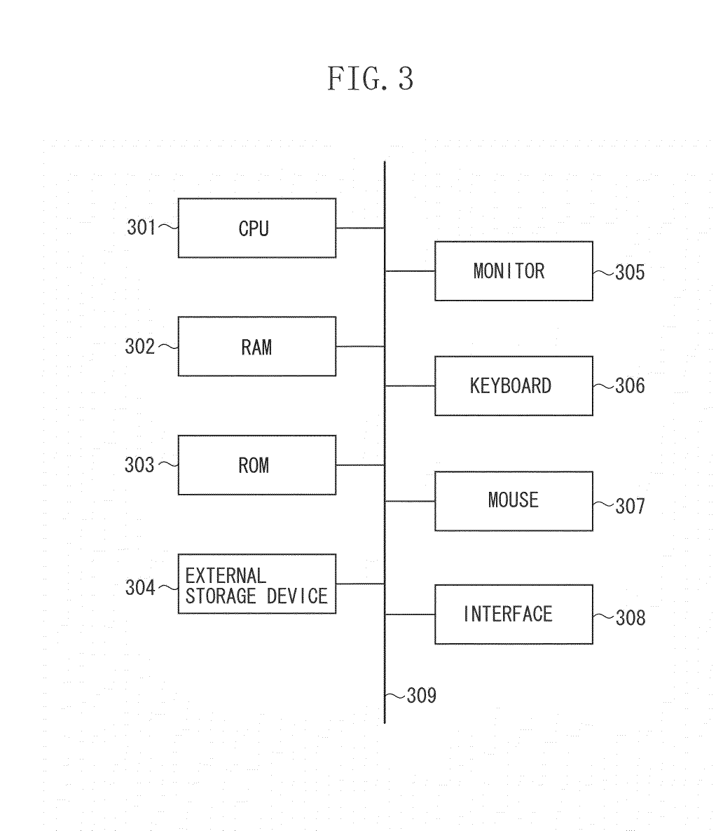

Next, a hardware configuration of the image processing apparatus 10 will be described with reference to FIG. 3. Referring to FIG. 3, as the hardware configuration, the image processing apparatus 10 includes a central processing unit (CPU) 301, a memory (random access memory (RAM)) 302, a control memory (read only memory (ROM)) 303, an external storage device 304, a monitor 305, a keyboard 306, a mouse 307, and an interface 308. A control program for realizing an image processing function according to the present exemplary embodiment, and data to be used when the control program is executed are stored in the external storage device 304. The control program and data are loaded to the RAM 302 via a bus 309 under control of the CPU 301 when needed, and are executed by the CPU 301, thereby functioning as respective units, which will be described below.

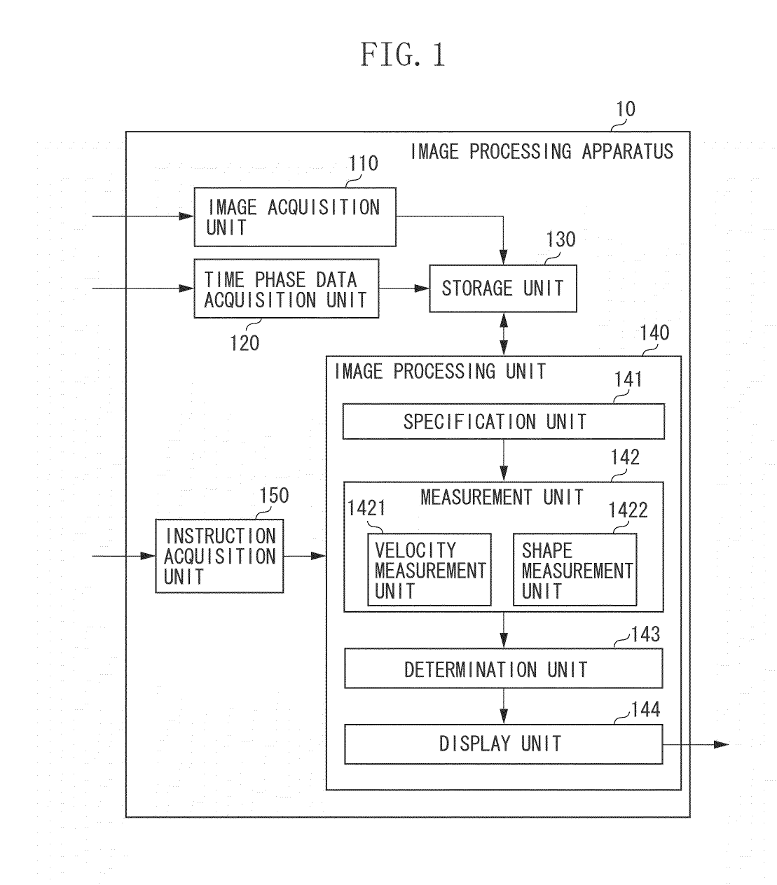

Next, a functional configuration of the image processing apparatus 10 according to the present exemplary embodiment will be described with reference to FIG. 1. FIG. 1 is a block diagram illustrating the functional configuration of the image processing apparatus 10. The image processing apparatus 10 includes an image acquisition unit 110, a time phase data acquisition unit 120, a storage unit 130, an image processing unit 140, and an instruction acquisition unit 150.

Further, the image processing unit 140 includes the specification unit 141, the measurement unit 142, the determination unit 143, and a display unit 144. Further, the measurement unit 142 includes a velocity measurement unit 1421, and a shape measurement unit 1422.

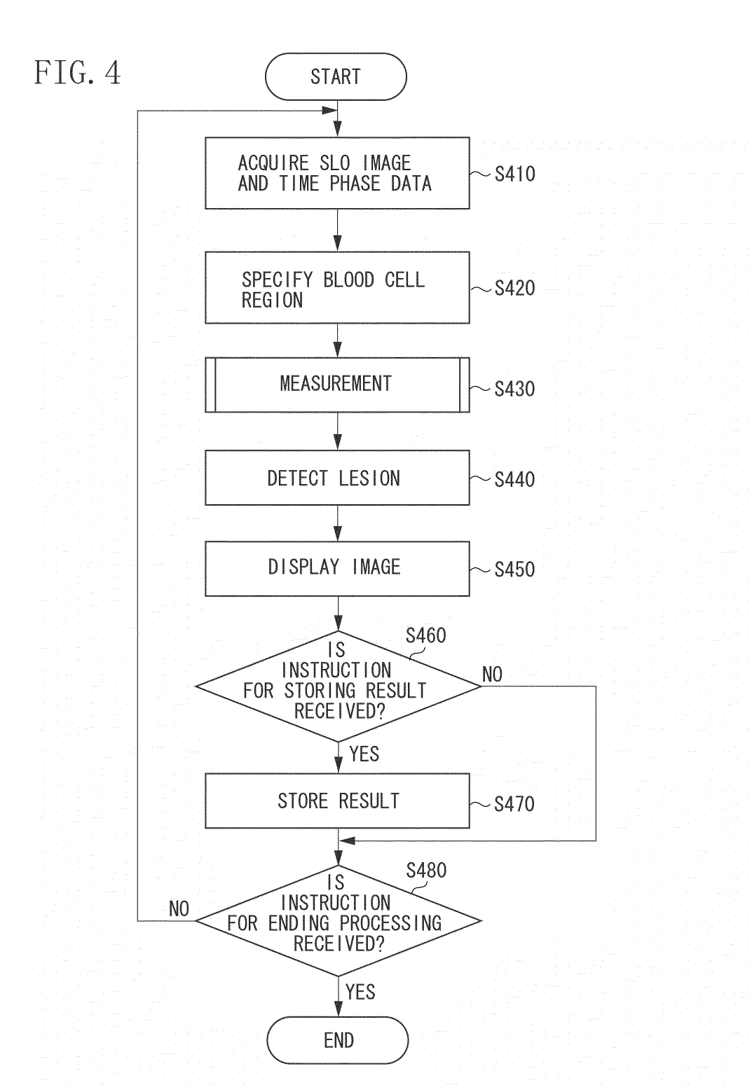

Functions of the respective blocks included in the image processing apparatus 10 will be described in association with a specific execution procedure of the image processing apparatus 10 illustrated in a flowchart of FIG. 4.

In step S410, the time phase data acquisition unit 120 requests the time phase data acquisition apparatus 30 to acquire time phase data P of a biological signal. In the present exemplary embodiment, the time phase data acquisition apparatus 30 is embodied by a sphygmograph, and acquires pulse wave data P from a lobule of an auricle (an earlobe) of a subject. Since the time phase data acquisition apparatus 30 acquires and transmits corresponding time phase data P in response to the acquisition request, the time phase data acquisition unit 120 receives the pulse wave data P from the time phase data acquisition apparatus 30 via the LAN 40. The time phase data acquisition unit 120 stores the received time phase data P in the storage unit 130.

The image acquisition unit 110 requests the SLO image capturing apparatus 20 to acquire an SLO moving image D captured at a fixation target position F, and the fixation target position F. In the present exemplary embodiment, the SLO image capturing apparatus 20 sets the fixation target position F to a parafovea of a macular portion, and a focus position to a position around an outer layer of a retina (B5 illustrated in FIG. 5A), and acquires an SLO moving image D (illustrated in FIG. 5B). A method for setting an image capturing position is not limited thereto, and an image capturing position maybe set to an arbitrary position.

As available timing arrangement, there maybe two ways. One is that the image acquisition unit 110 starts to acquire an SLO moving image D in synchronization with a certain phase of time phase data P acquired by the time phase data acquisition apparatus 30. The other is that pulse wave data P and an SLO moving image D start to be acquired simultaneously immediately after acquisition of the SLO moving image D is requested. In the present exemplary embodiment, time phase data P and an SLO moving image D start to be acquired immediately after acquisition of the SLO moving image D is requested.

Since the SLO image capturing apparatus 20 acquires and transmits the SLO moving image D and the fixation target point F in response to the acquisition request, the image acquisition unit 110 receives the SLO moving image D and the fixation target position F from the SLO image capturing apparatus 20 via the LAN 40. The image acquisition unit 110 stores the received SLO moving image D and the fixation target position F in the storage unit 130. In the present exemplary embodiment, the SLO moving image D is a moving image with frames already registered with one another.

In step S420, the specification unit 141 specifies a blood cell region and a range where a blood cell moves (a capillary vessel region) from the SLO moving image D. More specifically, the specification processing is performed by the following procedures.

i) The specification unit 141 generates a difference image between adjacent frames in the SLO moving image D. ii) The specification unit 141 specifies a region with a luminance value of a threshold value Td or larger as a blood cell region in each frame of a difference moving image. iii) The specification unit 141 calculates a luminance statistic in a frame direction at each x-y position in the difference moving image, and specifies a region with a luminance dispersion of a threshold value Tv or larger as a capillary vessel (blood cell moving) region. The processing for specifying a blood cell is not limited to this method, and an arbitrary known method may be used for this specification.

In step S430, the measurement unit 142 measures a vascular diameter in the capillary vessel region specified in step S420, and then measures the moving velocity of a leukocyte in the capillary vessel region.

A specific procedure for measuring the diameter of the capillary vessel and the moving velocity of the leukocyte will be described in detail in a description of steps 610 to 640.

In step S440, the determination unit 143 requests the data server 50 to transmit normal value data regarding an average value of the moving velocity of a leukocyte corresponding to the measured vascular diameter of the capillary vessel, and a pulsation coefficient. The image acquisition unit 110 acquires the normal values, and stores the acquired normal values in the storage unit 130.

The determination unit 143 detects the capillary vessel as a lesion candidate region in a case where any of the following conditions i) and ii) is satisfied.

i) A comparison of the average value of the moving velocity of the blood cell and the value of the pulsation coefficient measured in step S430 with the normal values reveals that any value thereof is beyond the range of the normal value. ii) A variation (a dispersion) in the average value of the moving velocity of the blood cell and the value of the pulsation coefficient measured in step S430 among regions is calculated for each vascular diameter, and the dispersion is equal to or larger than a threshold value. The method for setting the regions may be an arbitrary setting method. In the present exemplary embodiment, a region of visibility less than approximately 2 degrees around a fovea is divided into four regions of an upper side, a lower side, an ear side, and a nose side.

Instep S450, the display unit 144 displays and places side-by-side on the monitor 305, the SLO moving image D and an image of the capillary vessel region specified in step S420 superimposing the measurement values measured in step S430 and the lesion candidate region detected in step S440. The display method is not limited thereto, and an arbitrary known display method may be used to display the images. For example, the display unit 144 may be configured to allow a selection of information (the image feature, the measurement values, and the lesion candidate) to be superimposed on the SLO moving image D from a graphical user interface (GUI) such as a list, and display only the selected information in a superimposed manner.

In step S460, the instruction acquisition unit 150 acquires, from outside the image processing apparatus 10, an instruction about whether to store the SLO moving image D, the capillary vessel region specified in step S420, the measurement values measured in step S430, the lesion candidate region, and the fixation target position F into the data server 50. This instruction is input by an operator via, for example, the keyboard 306 and the mouse 307. If an instruction for storing the result is received (YES in step S460), the processing proceeds to step S470. If an instruction for storing the result is not received (NO in step S460), the processing proceeds to step S480.

In step S470, the image processing unit 140 transmits, to the data server 50, a date and time of the examination, information for identifying the examined eye, the SLO moving image D and the image feature, the measured values, the lesion candidate, and the fixation target position F while associating them with one another.

In step S480, the instruction acquisition unit 150 acquires, from outside the image processing apparatus 10, an instruction about whether to end the processing for the SLO moving image D by the image processing apparatus 10. This instruction is input by the operator via the keyboard 306 and the mouse 307. If an instruction for ending the processing is received (YES in step S480), the analysis processing is ended. On the other hand, if an instruction for continuing the processing is received (NO in step S480), the processing returns to step S410, in which processing for a next eye to be examined is performed (or the processing for the same examined eye is performed again).

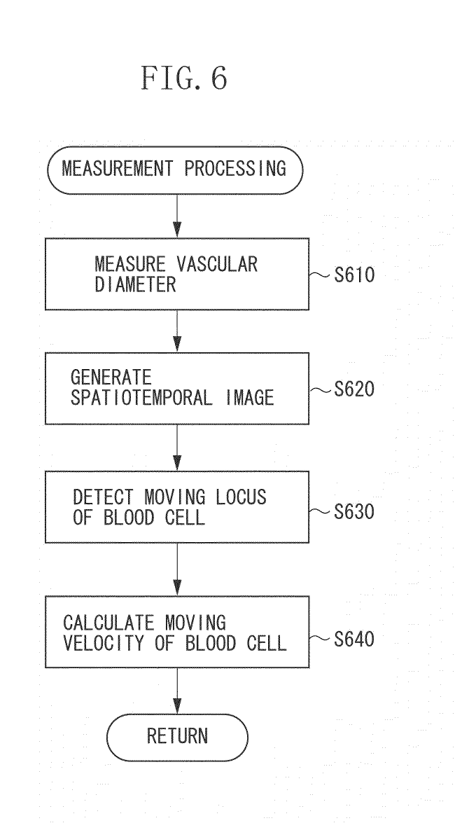

Next, details of the processing performed in step S430 will be described with reference to a flowchart illustrated in FIG. 6.

In step S610, the measurement unit 142 sets a central axis of each capillary vessel specified in step S420, and the shape measurement unit 1422 measures a vascular diameter along each central axis. The shape measurement unit 1422 measures the vascular diameter as a range of a luminance value smaller than a threshold value (VW illustrated in FIG. 5B) in a direction perpendicular to the central axis.

In step S620, the velocity measurement unit 1421 generates a spatiotemporal image along the central axis of each capillary vessel. As illustrated in FIG. 5D, in the spatiotemporal image, a horizontal axis is expressed by a position on the central axis and a vertical axis is expressed by a time, and the spatiotemporal image corresponds to a curved cross-sectional image cut out from the SLO moving image D along the vascular central axis. In the present exemplary embodiment, the measurement unit 142 sets the central axis by performing thinning processing on the capillary vessel region. However, the method for setting the central axis is not limited thereto, and an arbitrary known setting method may be used to set the central axis.

In step S630, the velocity measurement unit 1421 detects a moving locus of a blood cell in each spatiotemporal image. As illustrated in FIG. 5D, in the spatiotemporal image, a moving locus M of a leukocyte is expressed by a straight line of a high luminance. Although an arbitrary known method for detecting a straight line can be used therefor, in the present exemplary embodiment, Hough transformation is used to detect the moving locus of the leukocyte.

In step S640, the velocity measurement unit 1421 calculates the moving velocity of the blood cell based on an angle of the moving locus of the blood cell detected in each spatiotemporal image.

Since leukocytes only account for approximately 3% in a blood cell component, as indicated by an upper graph illustrated in FIG. 5F, a time when the velocity of a blood cell can be measured (indicated by dots) is limited compared to a change in velocity of actual blood flow (indicated by a solid line). Therefore, generally, an image corresponding to a plurality of heartbeats is acquired and velocities are measured therefrom, and then, as indicated by a lower graph illustrated in FIG. 5F, the measured blood cell velocity values are plotted with respect to a phase (θ) of a wave pulse (instead of a measured time).

In the present exemplary embodiment, the average value of the blood cell velocity, and the pulsation coefficient PI, which is expressed by the following equation, are calculated for each capillary vessel:

Pulsation coefficient PI=(PSV−EDV)/Va, in which PSV=(a maximum velocity of blood flow at the end-systole), EDV=(a velocity of blood flow at the end-diastole), and Va=(an average value of the velocity of blood flow). A pulsation cycle Cy, a position of the end-systole Ph, and a position of the end-diastole P1 are determined based on pulse wave data (illustrated in FIG. 5E).

The present exemplary embodiment detects an abnormality in the moving velocity of the leukocyte in the SLO moving image D captured with the focus position set to the outer layer (B5 illustrated in FIG. 5A) of the retina of the macular portion, but the present invention is not limited thereto. For example, an abnormality in moving velocity of a blood cell in a capillary vessel may be detected from an SLO moving image obtained by capturing a papillary edge of an optic nerve. Alternatively, an abnormality in moving velocity of a red blood cell may be detected from an SLO moving image (illustrated in FIG. 5C) captured with the focus position set to an inner layer (B2 to B4 illustrated in FIG. 5A) of a retina.

According to the above-described configuration, the image processing apparatus 10 measures the moving velocity of a blood cell after specifying a blood cell region from an SLO moving image obtained by capturing a parafovea of a macular portion, and compares the measured velocity with a normal value or a measured value in another region, thereby detecting an abnormality in a moving state of the blood cell.

As a result, an abnormality in blood flow caused in a capillary vessel of an ocular portion can be detected non-invasively and automatically.

A second exemplary embodiment makes registration between frames in an SLO moving image, and measures the shape of a capillary vessel, the density of capillary vessels, and the moving velocity of a blood cell. The second exemplary embodiment will be described based on an example that determines an abnormality from multiple aspects with use of the measured shape of the capillary vessel, vascular density distribution, and moving velocity of the blood cell, whereby an early-stage lesion generated at a capillary vessel in an ocular portion can be detected with a higher degree of accuracy.

According to the second exemplary embodiment, a blood cell region can be specified with a higher degree of accuracy. Further, an early-stage lesion generated at a capillary vessel in an ocular portion can be accurately detected through detection of an abnormality in both morphology (a shape and distribution) and a function of a capillary vessel.

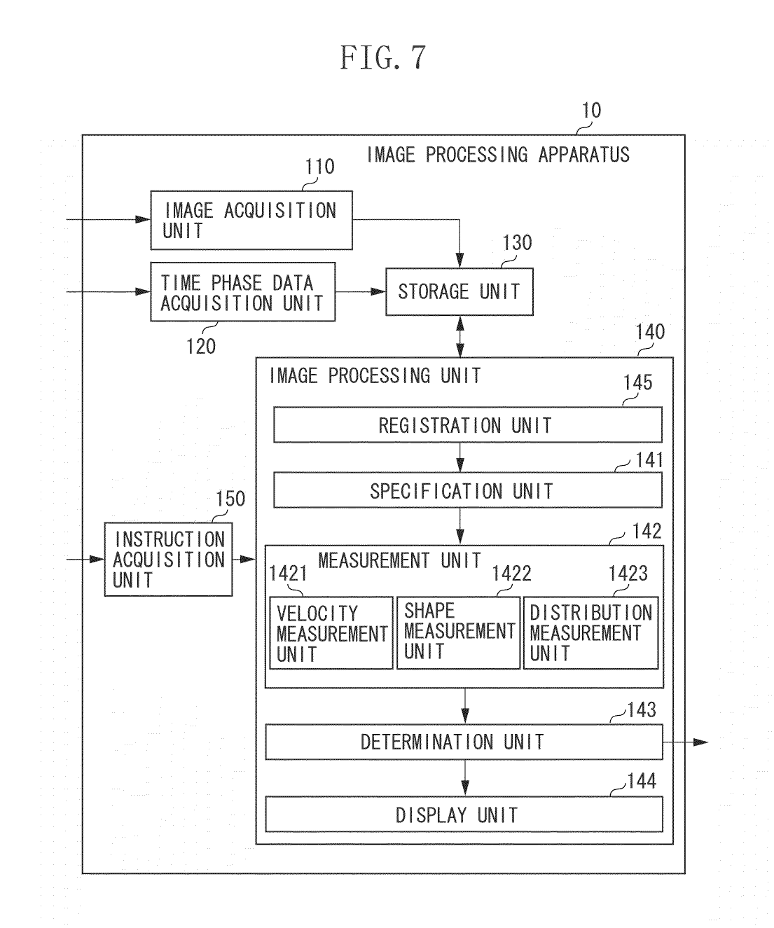

Next, FIG. 7 is a functional block diagram of the image processing apparatus 10 according to the present exemplary embodiment. The second exemplary embodiment is different from the first exemplary embodiment in terms that, in the second exemplary embodiment, the image processing unit 140 includes an registration unit 145, and the measurement unit 142 includes a distribution measurement unit 1423.

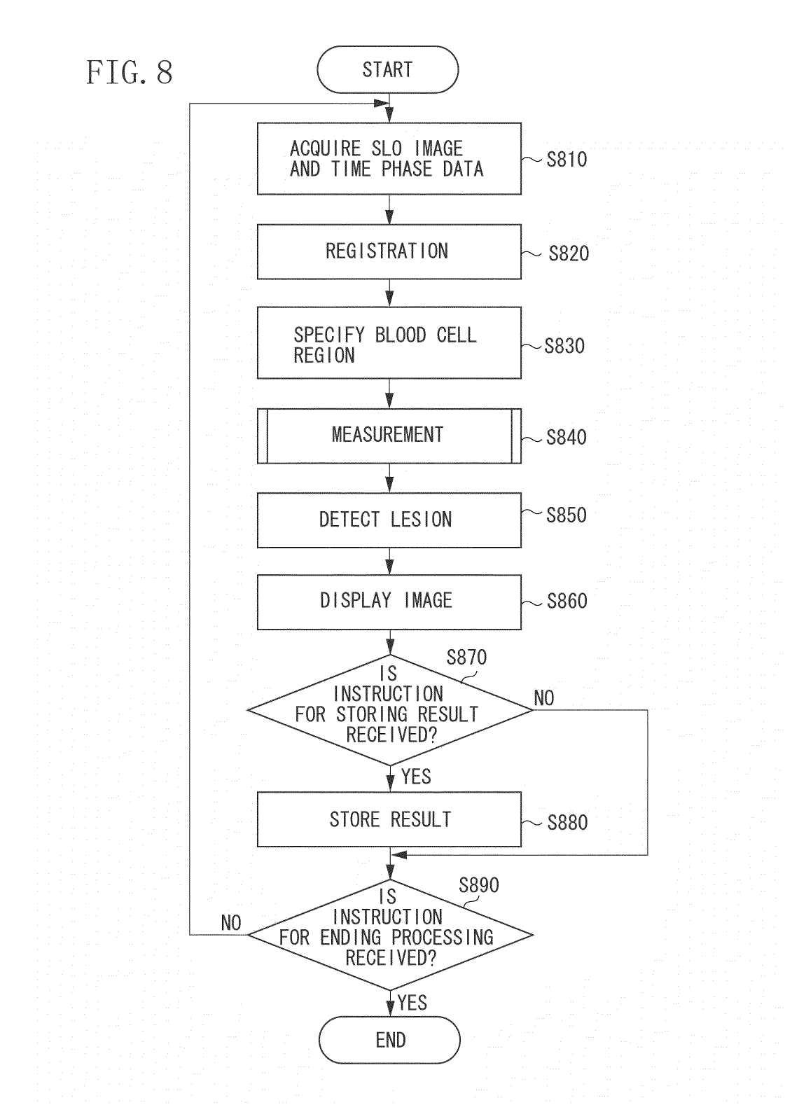

Further, FIG. 8 illustrates an image processing flow according to the present exemplary embodiment. In this flow, steps other than steps S820, S840, S850, and S860 are similar to the first exemplary embodiment. Therefore, in the description of the present exemplary embodiment, only processes performed in steps S820, S840, S850, and S860 will be described.

In step S820, the registration unit 145 reads an SLO moving image D from the storage unit 130, and makes registration between frames in the SLO moving image D.

More specifically, the following procedures are performed.
i) The registration unit 145 sets a reference frame, based on which the frames are registered. In the present exemplary embodiment, a frame having a smallest frame number is set as the reference frame. The method for setting the reference frame is not limited thereto. An arbitrary setting method may be used to set the reference frame. For example, a reference frame number specified by a user may be acquired from the instruction acquisition unit 150, and the reference frame may be set therefrom.
ii) The registration unit 145 roughly determines corresponding positions (performs rough registration) between frames. An arbitrary registration method may be used therefor. In the present exemplary embodiment, the rough registration is performed with use of a correlation function as a pixel similarity evaluation function, and Affine transformation as a coordinate transformation method.
iii) The registration unit 145 makes precise registration between frames based on data of rough corresponding positional relationships between frames.

In the present exemplary embodiment, the registration unit 145 makes precise registration between frames in the roughly-registered moving image acquired from the process ii) with use of the Free Form Deformation (FFD) method, which is one of non-rigid registration methods.

The precise registration method is not limited thereto, and an arbitrary registration method may be used for the precise registration.

The present exemplary embodiment acquires a combination of registration parameters by which all frames of the SLO moving image D maximally approach the reference frame with use of pixel similarity based on a pixel value, but the registration method is not limited thereto. For example, the registration unit 145 may detect an image feature of an observation target in each frame of an SLO moving image D (for example, a fovea or a vascular bifurcation). Further, the registration unit 145 may make registrations between the frames in the SLO moving image D in such a manner that the positions of the image features are most precisely registered.

In step S840, after measuring a vascular shape in the capillary vessel region specified in step S830, the measurement unit 142 measures the density of capillary vessels and the moving velocity of a leukocyte in the capillary vessel region.

The shape measurement unit 1422 calculates not only the vascular diameter, like the first exemplary embodiment, but also a vascular curvature as measurement items of the shape of the capillary vessel. It is considered that, as a degree of a vascular curve increases (as a curvature radius reduces), it becomes more difficult for a blood cell to flow therethrough, thereby increasing a probability of occurrence of an abnormality in a velocity of the blood cell.

Further, the distribution measurement unit 1423 measures a vascular density, which indicates how large loss (occlusion) occurs in the capillary vessels. The vascular density is expressed by a total value of lengths of capillary vessels existing per unit region. Thus, as the vascular density becomes lower, this indicates that more loss (occlusion) of a capillary vessel occurs in the region.

The method for measuring the moving velocity of a blood cell is similar to the first exemplary embodiment, and, therefore, a description thereof will be omitted here.

In step S850, the determination unit 143 detects the region as a lesion candidate region, in a case where the shape of the capillary vessel, the vascular density distribution, and the value of the blood cell velocity measured in step S840 are beyond ranges of normal values, or a variation (a dispersion) among regions is equal to or larger than a threshold value.

A shape abnormality and a functional abnormality are detected for each capillary vessel, and a distribution abnormality is detected for each region.

In the present exemplary embodiment, each region is classified into one of three types, and is provided with a rank indicating a probability of a lesion. The three types are as follows:
1. A region having only one of a shape abnormality, a distribution abnormality, and a velocity abnormality;
2. A region having two of a shape abnormality, a distribution abnormality, and a velocity abnormality; and
3. A region having all of a shape abnormality, a distribution abnormality, and a velocity abnormality.

In the present exemplary embodiment, the rank is determined in such a manner that type 3 indicates a region having a highest probability of occurrence of a lesion, type 2 indicates a region having an intermediate probability of occurrence of a lesion, and type 1 indicates a region having a low probability of occurrence of a lesion (although it is still a lesion candidate region).

In step S860, the display unit 144 displays the SLO moving image D, the capillary vessel region specified in step S820, and the lesion candidate region detected in step S850 on the monitor 305.

In the present exemplary embodiment, the display unit 144 displays, adjacent to the SLO moving image D, an image showing the capillary vessel region with the colored lesion candidate region superimposed thereon.

The display method is not limited thereto, and an arbitrary display method may be used to display the images. For example, the lesion region may be surrounded by a colored frame on the image of the capillary vessel region, or an arrow may be added near the lesion candidate region. Alternatively, a color or an arrow type may be changed according to the type of the lesion candidate, or the display may be configured to allow a colored frame or an arrow indicating the lesion candidate region to be selectively shown or hidden on the image of the capillary vessel. Alternatively, the lesion candidate region may be displayed in such a manner that a shape abnormality and a functional abnormality are differently colored, or a different color is added according to a probability of the lesion.

The present exemplary embodiment detects any of a shape abnormality, an abnormality in distribution of capillary vessels, and an abnormality in a moving state of a blood cell in a capillary vessel region as a lesion candidate region, but the present invention is not limited thereto. For example, only a region having both a shape abnormality and an abnormality in a blood cell velocity may be detected as a lesion candidate to reduce the number of false-positive results (a result that is detected as a lesion candidate but is not a lesion actually). In this case, any of the following methods may be used for efficient detection.
i) The moving velocity of a blood cell is measured for a region having a capillary vessel with a shape abnormality, and this region is detected as a lesion candidate in a case where the blood cell velocity is abnormal.
ii) The shape is measured for a capillary vessel having an abnormality in a blood cell velocity, and this capillary vessel is detected as a lesion candidate in a case where the capillary vessel has an abnormal shape.

Further, the present exemplary embodiment detects an abnormality in shape of a capillary vessel, vascular density distribution, and moving velocity of a leukocyte in an SLO moving image captured with the focus position set to an outer layer (B5 illustrated in FIG. 5A) of a retina in a macular portion, but the present invention is not limited thereto. For example, an abnormality in shape of a capillary vessel, vascular density distribution, and moving velocity of a leukocyte may be determined in an SLO moving image obtained by capturing a papillary edge of an optic nerve. Alternatively, an abnormality in shape of a capillary vessel, vascular density distribution, and moving velocity of a red blood cell may be detected in an SLO moving image (illustrated in FIG. 5C) captured with the focus position set to an inner layer (B2 to B4 illustrated in FIG. 5A) of a retina.

According to the above-described configuration, the image processing apparatus 10 makes registration between frames in an SLO moving image D, and measures the shape of a capillary vessel, the density of capillary vessels, and the moving velocity of a blood cell. The image processing apparatus 10 determines an abnormality from multiple aspects with use of the measured shape of the capillary vessel, density distribution of the capillary vessels, and moving velocity of the blood cell, thereby detecting an early-stage lesion generated in a capillary vessel of an ocular portion with higher degree of accuracy.

As a result, a blood cell region can be detected move accurately. Further, an early-stage lesion generated in a capillary vessel of an ocular portion can be detected through detection of an abnormality in both morphology (a shape and distribution) and a function of the capillary vessel.

Compared to the second exemplary embodiment, a third exemplary embodiment specifies a capillary vessel and a blood cell region after determining an exceptional frame including an eye blink, an involuntary eye movement during fixation, or a failure in aberration correction in an SLO moving image, and changing the image processing method for the exceptional frame or a frame adjacent to the exceptional frame. The third exemplary embodiment measures the shape of a capillary vessel, vascular density distribution, and the moving velocity of a blood cell in the specified region. The third exemplary embodiment compares the measured value with a normal value or a measured value in another region to thereby detect an abnormality in the shape of the capillary vessel or the distribution, and an abnormality in the moving state of the blood cell.

More specifically, the third exemplary embodiment will be described based on an example functioning in the following manner. An exceptional frame determination unit 1451 determines an exceptional frame based on a luminance value, an image distortion amount, a signal/noise (S/N) ratio, and a displacement amount relative to a reference frame for each frame at the time of registration between frames in an SLO moving image D. The specification unit 141 specifies a high-luminance blood cell region, excluding the exceptional frame. The measurement unit 142 measures a shape and density distribution in the specified capillary vessel region. Further, the measurement unit 142 detects a locus of a blood cell, excluding the exceptional frame, to measure the moving velocity of the blood cell. The determination unit 143 detects a lesion candidate region by comparing the measured value with a normal value of the measured value or a measured value in another region. The determination unit 143 can also determine a lesion candidate by comparing measurement results of fundus images captured at different shooting times with one another.

According to this configuration, an early-stage lesion generated in a capillary vessel can be detected non-invasively and automatically, even in a case where a moving image of a fundus includes an exceptional frame.

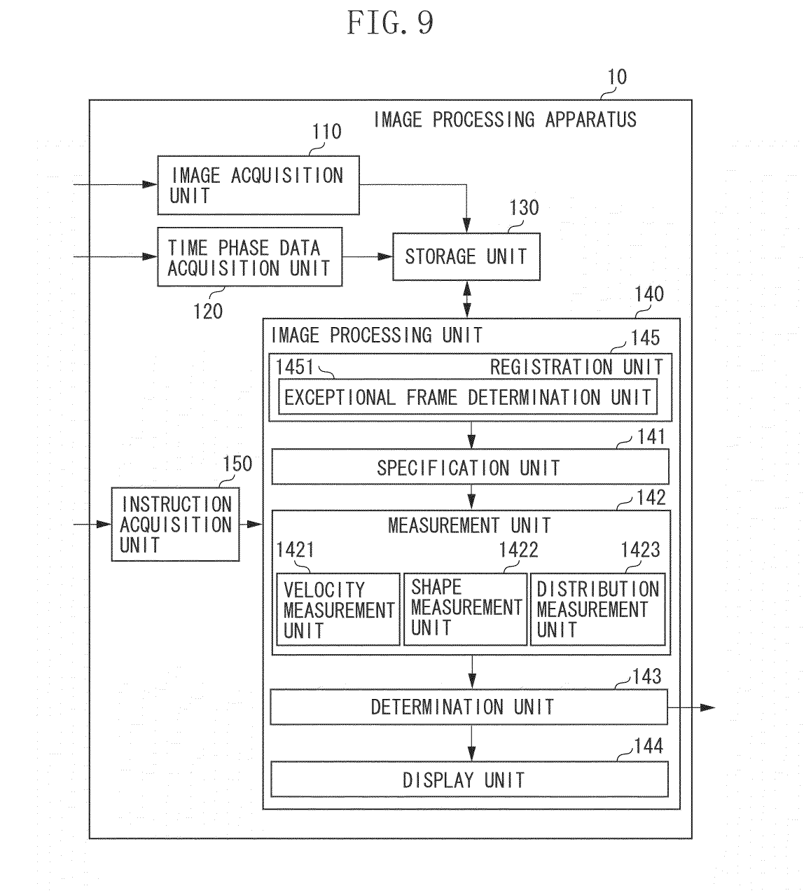

Next, FIG. 9 is a functional block diagram illustrating the image processing apparatus 10 according to the present exemplary embodiment. The third exemplary embodiment is different from the second exemplary embodiment in terms that, in the third exemplary embodiment, the registration unit 145 includes the exceptional frame determination unit 1451.

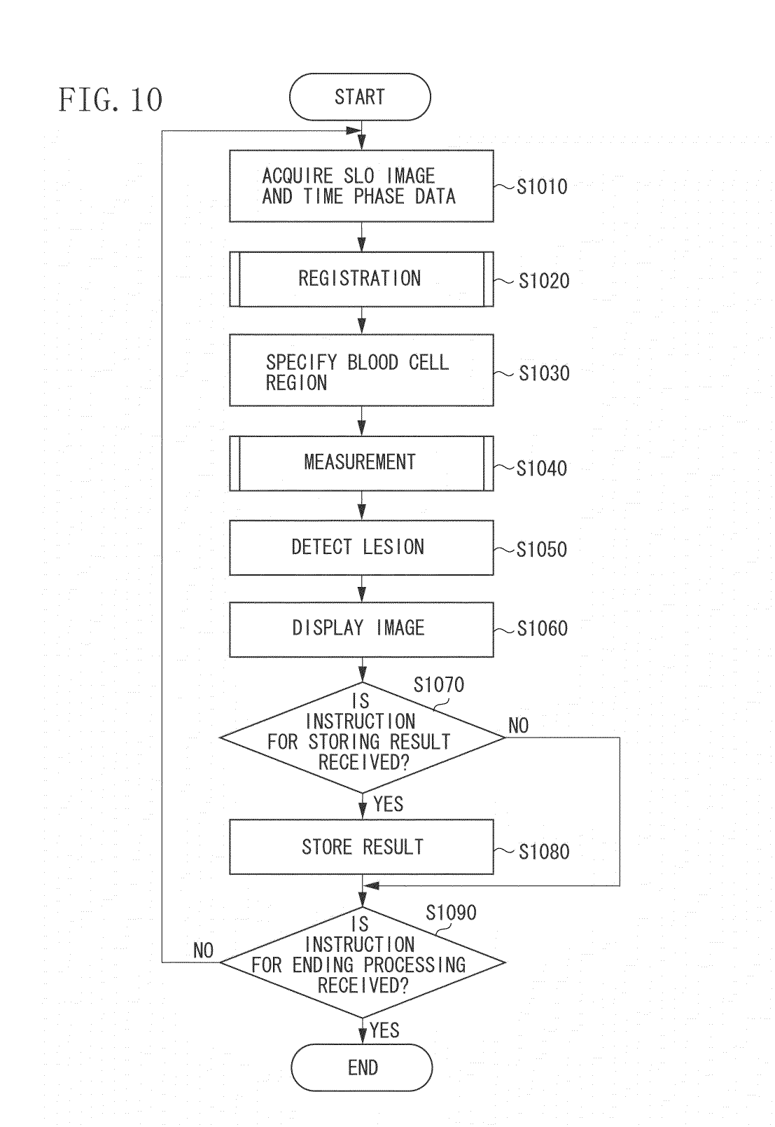

Further, FIG. 10 illustrates an image processing flow according to the present exemplary embodiment. This flow is similar to the second exemplary embodiment except for steps S1020, S1030, and S1040. Therefore, in the description of the present exemplary embodiment, only processes performed in steps S1020, S1030, and S1040 will be described.

In step S1020, the registration unit 145 makes registration between frames in an SLO moving image D. First, the exceptional frame determination unit 1451 determines whether each individual frame is an exceptional frame, and the registration unit 145 selects a reference frame. Next, the registration unit 145 makes rough registration between the frames with use of Affine transformation, and after that, makes precise registration between the frames with use of a known non-rigid registration method. Lastly, the exceptional frame determination unit 1451 determines whether each frame in the registered SLO moving image is an exceptional frame.

In step S1030, the specification unit 141 specifies a blood cell region or a capillary vessel region (a blood cell moving region) with use of frames other than the exceptional frame determined in step S1020.

Basically, the process in step S1020 is similar to step S420, but is different in that, in this case, when the specification unit 141 generates a difference image between adjacent frames in an SLO moving image D in the process i), the specification unit 141 does not perform differential processing in a case where at least one of images that are targets of the differential processing is an exceptional frame. Therefore, when the specification unit 141 calculates a luminance statistic in a frame direction at each x-y position in a difference moving image and specifies a region having a luminance dispersion of the threshold value Tv or larger as a capillary vessel (blood cell moving) region in the process iii), the specification unit 141 excludes a range corresponding to the exceptional frame from targets of the calculation of the luminance statistic.

As a result, a blood cell region and a capillary vessel region can be correctly specified, even in a case where an exceptional frame exists.

In step S1040, the measurement unit 142 measures the vascular shape in the capillary vessel region specified in step S1030, and then measures the density of capillary vessels and the moving velocity of a leukocyte in the capillary vessel region.

The method for measuring a shape of a capillary vessel and a vascular density is similar to the second exemplary embodiment, and therefore a description thereof will be omitted here.

In the blood cell velocity measurement processing (steps S610 to S640 in the first exemplary embodiment), only the method for detecting a moving locus of a blood cell (step S630) is different from the first exemplary embodiment.

More specifically, when the measurement unit 142 detects a high-luminance moving locus of a blood cell by Hough transformation, the measurement unit 142 multiplies an evaluation value in a θp space by a weight w proportional to a length passing through the exceptional frame, in a case where an equation that is a straight line candidate may pass through the exceptional frame (in a case where the blood cell locus M extends close to the exceptional frame in a spatiotemporal image).

As a result, the moving locus M of the blood cell can be robustly detected as a straight line, even in a case where the moving locus M of the blood cell is partially interrupted due to the exceptional frame.

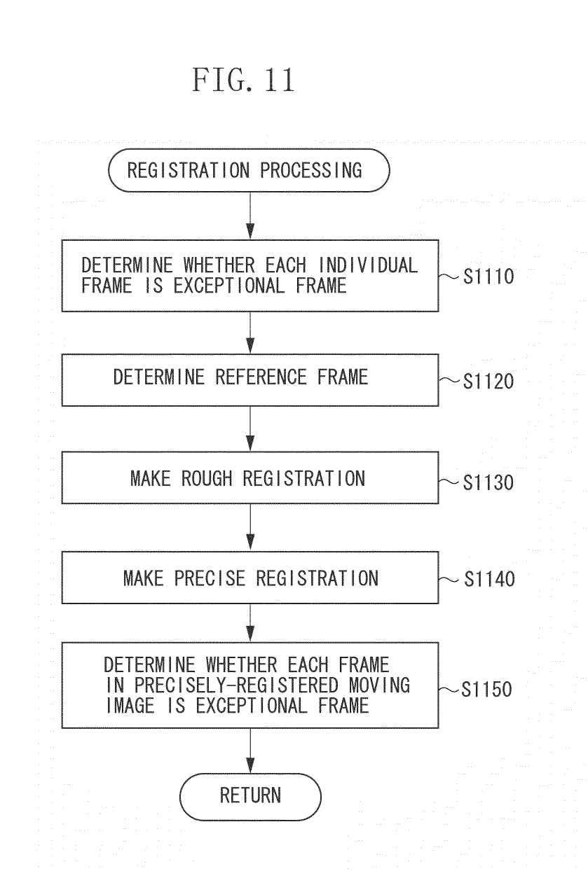

Next, details of the process performed in step S1020 will be described with reference to a flowchart illustrated in FIG. 11.

Steps S1120, S1130, and S1140 are similar to step S820 in the second exemplary embodiment, and therefore a description thereof will be omitted here.

In step S1110, the exceptional frame determination unit 1451 determines whether each individual frame is an exceptional frame.

The exceptional frame determination unit 1451 acquires an average luminance value Ai and a vascular region Vi in each frame Di as an image feature from the SLO moving image D. An arbitrary known vascular extraction method can be used as the method for acquiring a vascular region. In the present exemplary embodiment, the exceptional frame determination unit 1451 extracts a region having a luminance value of a threshold value T1 or smaller as a vascular region. Further, the exceptional frame determination unit 1451 also acquires an intersection portion Cin (n=1, . . . n4>=3) of a point sequence Bim (m=1, 2, . . . n3) acquired by thinning the vascular region Vi.

The exceptional frame detection unit detects a frame having an extremely low luminance due to an eye blink, a frame having an image distortion due to an involuntary eye movement during fixation, and a frame having a low S/N ratio (a ratio of signal to noise) due to a failure in aberration correction from each frame Di in the SLO moving image D as an exceptional frame.

In the present exemplary embodiment, if the above-described average luminance value Ai is equal to or smaller than a threshold value T2, it is estimated that the frame Di of each SLO moving image D has a luminance abnormality due to an eye blink, whereby this frame is determined as an exceptional frame. Further, if a value of a sum of squares of distances between the above-described vascular intersection portions Cin is different between adjacent frames by a threshold value T3 or larger, it is estimated that an image distortion occurs due to an involuntary eye movement during fixation, whereby this frame is determined as an exceptional frame. Further, if the S/N ratio is equal to or smaller than a threshold value T4, it is estimated that a failure occurs in aberration correction, and whereby this frame is determined as an exceptional frame.

The method for determining an exceptional frame is not limited thereto, and an arbitrary exception determination method may be used to determine an exceptional frame. For example, the exceptional frame determination unit 1451 may calculate a luminance statistic (an average value, a mode, or a maximum value) of a differential image acquired by performing differential processing on each frame, and in a case where the luminance statistic is equal to or smaller than a threshold value T5, it maybe estimated that a blur occurs due to a movement of a subject to thereby determine that this frame is an exceptional frame.

In step S1150, the exceptional frame determination unit 1451 determines whether each frame in the precisely-registered SLO image generated in step S1140 is an exceptional frame.

More specifically, the exceptional frame determination unit 1451 calculates a displacement amount between an image feature (the vascular intersection Cin) in the reference frame set in step S1120 and an image feature in a non-reference frame, and determines a frame having a displacement amount larger than an allowable value as an exceptional frame. In the present exemplary embodiment, a displacement amount vector (x, y, θ, sx, sy), which has a translation (x, y), a rotation θ, and an enlargement rate (sx, sy) as components, is defined as the displacement amount relative to the reference frame. In a case where at least one of conditions, x>Tx, y>Ty, θ>Tθ, sx>Tsx, and sy>Tsy is satisfied, this frame is determined as an exceptional frame.

The definition of the displacement amount is not limited thereto, and may use an arbitrary value capable of indicating a degree of displacement (a scalar quantity or a vector quantity). For example, a ratio at which a reference region to be observed or measured is included in each frame, for example, (an area of an entire reference region)/(an area of the reference region included in each frame Di) maybe defined as the displacement amount.

The present exemplary embodiment detects an abnormality in shape of a capillary vessel, vascular density distribution, and moving velocity of a leukocyte in an SLO moving image captured with the focus position set to an outer layer (B5 illustrated in FIG. 5A) of a retina in a macular portion, but the present invention is not limited thereto. For example, an abnormality in shape of a capillary vessel, vascular density distribution, and moving velocity of a leukocyte may be determined in an SLO moving image obtained by capturing a papillary edge of an optic nerve. Alternatively, an abnormality in shape of a capillary vessel, vascular density distribution, and moving velocity of a red blood cell may be detected in an SLO moving image (illustrated in FIG. 5C) captured with the focus position set to an inner layer (B2 to B4 illustrated in FIG. 5A) of a retina.

According to the above-described configuration, compared to the second exemplary embodiment, the image processing apparatus 10 determines an exceptional frame including an eye blink, an involuntary eye movement during fixation, or a failure in aberration correction in an SLO moving image. Further, the image processing apparatus 10 specifies a capillary vessel and a blood cell region after changing the image processing method for the exceptional frame or a frame adjacent to the exceptional frame. Then, the image processing apparatus 10 measures the shape of the capillary vessel, vascular density distribution, and the moving velocity of a blood cell in the specified region. Then, the image processing apparatus 10 compares the measured value with a normal value or a measured value in another region to thereby detect an abnormality in the shape of the capillary vessel or distribution of capillary vessels, or an abnormality in a moving state of the blood cell.

As a result, an early-stage lesion generated in a capillary vessel can be detected non-invasively and automatically, even in a case where an exceptional frame is included in a moving image of an ocular portion.

The above-described exemplary embodiments capture a moving image of an ocular portion by an adaptive optics SLO. However, the image capturing method is not limited thereto. A fundus camera including an adaptive optics system may be used to capture an image. In other words, the present invention can be realized by any ophthalmologic imaging apparatus capable of acquiring an image enabling observation of a blood cell in a blood vessel. Using the adaptive optics SLO enables specification of positional information of individual or collective leukocytes from an individual image, and therefore enables highly-accurate measurement of a moving state of blood flow compared to conventional apparatuses. Further, the adaptive optics SLO enables an extremely fine capillary vessel existing in a region around a macular portion to be applicable as an application target.

According to the above-described exemplary embodiments, an early-stage lesion generated in a capillary vessel of an ocular portion can be detected non-invasively and automatically.

In the above-described exemplary embodiments, the present invention is realized as an image processing apparatus. However, embodiments of the present invention are not limited to an image processing apparatus. For example, an embodiment of the present invention may be realized as software executed by a CPU of a computer. Further, a storage medium storing this software is also within the scope of the present invention.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-034346 filed Feb. 20, 2012, which is hereby incorporated by reference herein in its entirety.

What is claimed is:

1. An image processing apparatus comprising:
a memory; and
a processor, wherein the processor is configured to control:
a specification unit configured to specify a vascular region based on a movement of a blood cell in a moving image of an ocular portion captured by an ophthalmologic imaging apparatus including an adaptive optics system, and
a determination unit configured to determine presence of an abnormality based on the specified vascular region.

2. The image processing apparatus according to claim 1, wherein the specification unit specifies at least a partial vascular inner region based on a moving state acquired from the moving image, and
wherein the processor is further configured to control a measurement unit configured to measure a value indicating a feature of the vascular inner region and a value indicating a feature of the moving state for each partial region.

3. The image processing apparatus according to claim 2, wherein the measurement unit measures a velocity or a number of the blood cell, a diameter, a curvature, or a density of a blood cell moving region, or a shape or an area of a region where the blood cell moving region does not exist.

4. The image processing apparatus according to claim 2, wherein the determination unit determines a lesion candidate by comparing a result of the measurement with a normal value.

5. The image processing apparatus according to claim 2, wherein the determination unit determines a lesion candidate by comparing a result of the measurement with a result of a measurement measured in a different region.

6. The image processing apparatus according to claim 2, wherein the determination unit determines a lesion candidate by comparing a result of the measurement with a result of a measurement performed at a different shooting time.

7. The image processing apparatus according to claim 1, wherein the processor is further configured to control an exceptional frame determination unit configured to determine, from the moving image of the ocular portion, a frame in which at least one of a degree of a luminance abnormality, a degree of a distortion, a degree of a noise relative to a signal, and a displacement amount relative to a reference frame is greater than or equal to a predetermined threshold value,
wherein the specification unit specifies a blood cell region or a blood cell moving region after the determination of the exceptional frame.

8. A diagnostic support system comprising:
the image processing apparatus according to claim 1; and
a display,
wherein the processor is further configured to control a display unit to cause a result of the determination by the determination unit to be displayed on the display.

9. An image processing apparatus comprising:
a memory; and
a processor, wherein the processor configured to control:
a specification unit configured to specify a blood cell moving region from a moving image of an ocular portion acquired by an ophthalmologic imaging apparatus including an adaptive optics system,
a measurement unit configured to measure at least one of a position, a shape, and distribution regarding the specified blood cell moving region, and
a determination unit configured to determine a lesion candidate based on a result of the measurement.

10. An image processing apparatus for analyzing blood flow at a fundus, the image processing apparatus comprising:
a memory; and
a processor, wherein the processor is configured to control:
an acquisition unit configured to acquire a plurality of images captured at different timings from an ophthalmologic imaging apparatus capable of reducing an influence of an aberration for a subject by an adaptive optics system,
a specification unit configured to specify at least a partial vascular inner region based on a moving state acquired from the plurality of images,
a measurement unit configured to measure a value indicating a feature of the vascular inner region and a value indicating a feature of the moving state for each partial region, and
an output unit configured to output information regarding a lesion candidate region based on a partial region where at least one of the measured values falls in a predetermined range.

11. An image processing method comprising:
specifying a vascular region based on a movement of a blood cell in a moving image of an ocular portion captured by an ophthalmologic imaging apparatus including an adaptive optics system; and
determining presence of an abnormality based on the specified vascular region.

12. An image processing method comprising:
specifying a blood cell or a blood cell moving region from a moving image of an ocular portion acquired by an ophthalmologic imaging apparatus including an adaptive optics system;
measuring at least one of a position, a shape, and distribution regarding the specified blood cell or blood cell moving region; and
determining a lesion candidate based on a result of the measuring.

13. An image processing method for analyzing blood flow at a fundus, the image processing method comprising:
acquiring a plurality of images captured at different timing from an ophthalmologic imaging apparatus capable of reducing an influence of an aberration for a subject by an adaptive optics system;
specifying at least a partial vascular inner region based on a moving state acquired from the plurality of images;
measuring a value indicating a feature of the vascular inner region and a value indicating a feature of the moving state for each partial region; and
outputting information regarding a lesion candidate region based on a partial region where at least of one of the measured values falls in a predetermined range.
